(19) United States
(12) Patent Application Publication
(10) Pub. No.: US 2009/0045694 A1
(43) Pub. Date: Feb. 19, 2009

(54) MICROFIBER HIGH CURRENT CONDUCTION DEVICE

(76) Inventors: Hieyoung W. Oh, Bowdoin, ME (US); Jeffrey W. Richardson, Otisfield, ME (US)

Correspondence Address: TAYLOR & AUST, P.C.;ILLINOIS TOOL WORKS INC., 142 S. MAIN ST, PO BOX 560, AVILLA, IN, 46710, US

(21) Appl. No.: 12/173,170

(22) Filed: Jul. 15, 2008

Related U.S. Application Data
(60) Provisional application No. 60/964,812, filed on Aug. 15, 2007.

(51) Int. Cl. H02K 13/10

(52) U.S. Cl. 310/251

(57) ABSTRACT

A brush for the stator of an electric motor has microfibers establishing both mechanical and non-mechanical electrical connections to the commutator.

### CROSS-REFERENCE TO RELATED APPLICATIONS

The present regular U.S. patent application claims the benefits of U.S. Provisional Application for patent Ser. No. 60/964,812, filed on Aug. 15, 2007.

### FIELD OF THE INVENTION

The present invention relates generally to conductive devices, and more particularly to high current conduction devices. Still more particularly, the invention pertains to conductive brushes in electric motors.

### BACKGROUND OF THE INVENTION

A basic structure for an electric motor includes a stator and an armature. The stator includes a power supply, magnets and brushes. The magnets can be permanent magnets or electro magnets to provide a magnetic field. The brushes are electrically connected to the power supply. The armature includes a commutator and a coil on a rotatable shaft. The commutator has electrical contacts that interact with the brushes of the stator as the armature rotates to conduct electrical current between the power supply and the coil. The coil is positioned in the magnetic field of the stator magnets. The effect of the magnetic field on the electric current passing through the coil causes the armature to rotate. Since the armature and hence the commutator rotate, the commutator and the brushes are designed to provide moving contact for the flow of electric current therethrough.

It is known to provide the brushes as stationary blocks of carbon. To maintain proper cooperative electrical contact between the carbon block and the commutator surface, a spring element is used to bias the carbon block into contact with the commutator. In some known motor structures the spring is attached to the carbon block, and in other known structures a spring element is attached to a holder for the carbon block. Direct physical contact is provided between the carbon block and the commutator, and the frictional engagement causes wear and periodic need for replacement of the carbon block. Further, the springs can fail and disrupt the desired contact relationship between the brushes and the commutator. Replacement of the brushes, springs or the overall brush assembly can be difficult and time consuming, and necessarily requires the motor to be taken out of service for repair.

What is needed is a high current conduction device that is useful as a brush in an electric motor, and is less subject to wear than known devices for similar purposes.

### SUMMARY OF THE INVENTION

The present invention provides a high current conduction device including a plurality of microfibers held against or in closely spaced relationship to a surface to which electrical current transfer occurs.

In one aspect of one form thereof, the present invention provides a stator brush assembly for the stator of an electric motor with an electric lead for connecting to the power supply of the motor and microfibers for carrying current between the commutator and power supply.

In another aspect of another form thereof, the present invention provides a stator for an electric motor having a commutator, the stator having an electric power supply; an electric lead electrically connected to the power supply; and microfibers in a brush assembly in sufficient quantity and density to conduct electric current between the power supply and the commutator through electrical connections formed between the commutator and distal end portions of the microfibers.

In a still further aspect of a still further form thereof, the present invention provides an electric motor with an armature having a commutator with electrical contacts, and a stator with a power supply and microfibers in a brush assembly establishing electrical connections to the electrical contacts of the armature.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is a fragmentary perspective view of an electric motor having a microfiber high current conduction device as a stator brush therefore;

FIG. 2 is a perspective view of an electric motor brush assembly in accordance with one embodiment of the present invention;

FIG. 3 is a cross-sectional view of the brush assembly shown in FIG. 2, taken along line 3-3 of FIG. 2;

FIG. 4 is a perspective view of another embodiment of the present invention for a brush assembly in an electric motor;

FIG. 5 is a cross-sectional view of the brush assembly shown in FIG. 4, taken along line 5-5 of FIG. 4;

FIG. 6 is a side elevational view of one microfiber assembly in the brush assembly of FIGS. 4 and 5;

FIG. 7 is a cross-sectional view of the microfiber assembly shown in FIG. 6, taken along line 7-7 of FIG. 6;

FIG. 8 is a perspective view of another electric motor brush assembly in accordance with a further embodiment of the present invention;

FIG. 9 is a cross-sectional view of the brush assembly shown in FIG. 8, taken along line 9-9 of FIG. 8;

FIG. 10 is an elevational view of another microfiber assembly; and

FIG. 11 is a cross-sectional view of the microfiber assembly shown in FIG. 10, taken along line 11-11 of FIG. 10.

Before the embodiments of the invention are explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein are for the purpose of description and should not be regarded as limiting. The use herein of “including”, “comprising” and variations thereof is meant to encompass the items listed thereafter and equivalents thereof, as well as additional items and equivalents thereof.

### DETAILED DESCRIPTION OF THE PREFERRED EMBODIMENT

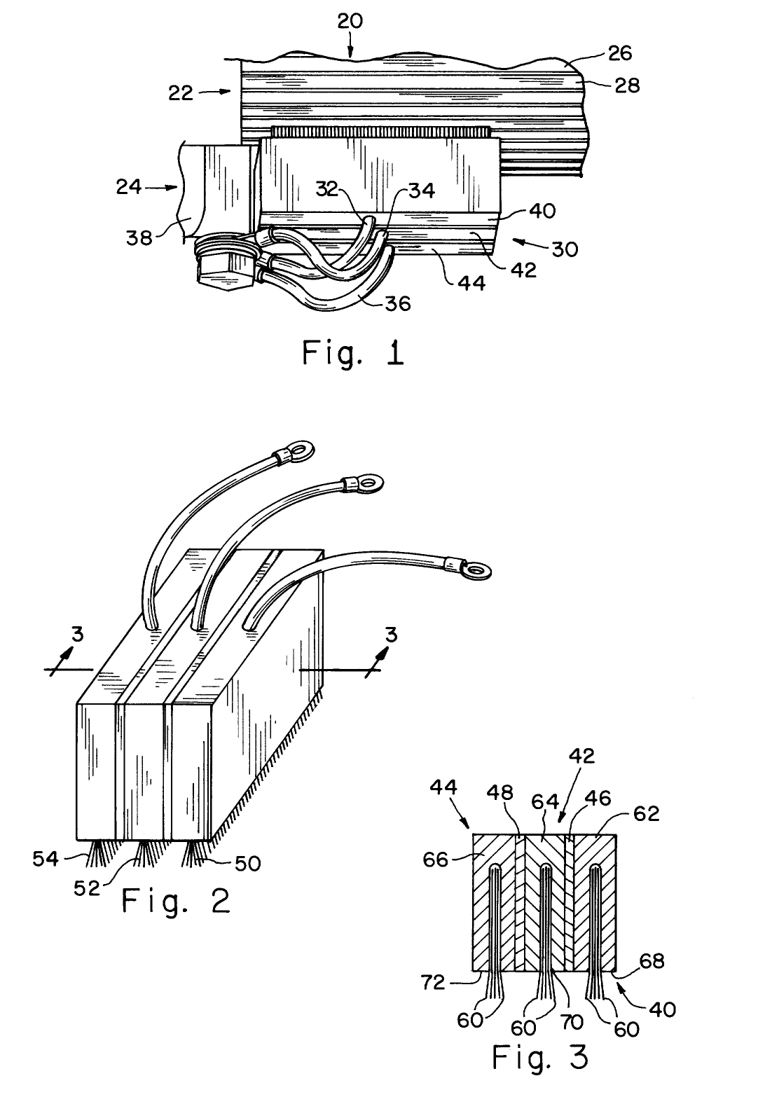

Referring now more specifically to the drawings and to FIG. 1 in particular, numeral 20 designates a fragmentary portion of an electric motor, having an armature 22 and a stator 24. Armature 22 includes a commutator 26 having cylindrically arranged electrical contacts 28. Stator 24 includes a microfiber high current conductive brush assembly 30 in accordance with one embodiment of the present invention. Brush assembly 30 is connected by electric leads 32, 34, 36 to a power supply 38. Brush assembly 30 conducts electrical current between power supply 38 and commutator 26. The purpose of brush assembly 30 is the same as the purposes for known brush assemblies of electric motors. While a single brush assembly 30 is shown in FIG. 1, it should be understood that electric motor 20 may include more than one brush assembly.

Referring now to FIG. 2, brush assembly 30 includes a plurality of microfiber assemblies 40, 42, 44 separated electrically from one another by insulating sheets 46 and 48. In the exemplary embodiment shown, three microfiber assemblies 40, 42, 44 separated by two insulating sheets 46 and 48 are illustrated; however, it should be understood that more or fewer microfiber assemblies can be used with or without insulating sheets to isolate the microfiber assemblies from each other. Each microfiber assembly 40, 42, 44 includes a group or row 50, 52, and 54 of conductive microfibers. Microfiber assemblies 40, 42, 44 are connected to electric leads 32, 34, 36, respectively.

With reference now to FIG. 3, each row 50, 52, 54 includes a plurality of tightly packed electrically conductive microfibers 60. Some microfibers 60, but not all microfibers 60 have been designated with reference numbers in the drawings. Microfibers 60 are retained in microfiber holders 62, 64, 66 separated by insulating sheets 46 and 48. Each microfiber holder 62, 64, 66 is connected to a flexible electric lead 32, 34, 36, respectively, and thereby places microfibers 60 in electrical contact with power supply 38 via leads 32, 34 and 36. As illustrated in FIG. 3, conductive microfibers 60 can be looped strands or filaments having distal portions of opposite ends exposed from edge surfaces 68, 70, 72 of microfiber holders 62, 64, 66, respectively, and looped mid-portions thereof held with in the microfiber holders. Microfiber holders 62, 64, 66 can be electrically conductive metal such as copper, aluminum or other metal, but also can be conductive plastics. In a preferred arrangement, conductive microfibers 60 are retained in microfiber holders 62, 64, 66 by mechanical means, such as crimping or compressing. Heat resistant, electrically conductive adhesives also can be used. Accordingly, within microfiber holders 62, 64, 66 the individual microfibers are securely held in a compact pack of fibers. The distal end portions of the microfibers that extend outwardly of microfiber holders 62, 64, 66 beyond surfaces 68, 70 and 72 can separate slightly from one another sufficiently to allow flexing of individual fibers.

Each microfiber 60 is a fine, hair-like filament made from conductive material, such as, for example, carbon, stainless steel, conductive plastics such as acrylic or nylon fibers, or any other conductive fiber-type filament or other microfiber such as ceramic that can be coated with conductive materials such as copper, silver, nickel, etc.; and that can be provided with diameters sufficiently small to induce ionization when in the presence of an electrical field. These are fibers with strands generally less than one denier, where one denier equals 1 gram per 900 meters of fiber. In one such embodiment, microfibers 60 generally have diameters less than about 150 microns. In one preferred arrangement, microfibers 60 are conductive filaments having diameters within a range of about 5 microns to about 100 microns. Microfibers of this type are mechanically flexible, high-strength, high stiffness fibers that can maintain physical contact over irregular surfaces. However, in contrast to known brushes for electric motors, individual fibers 60 have ultralow friction and a negligible wear from sliding contact. The individual fibers have sufficient resiliency and stiffness that when flexed against a surface will remain against the surface even if the surface is moving; however due to the light weight of each fiber the pressure of contact is low. Accordingly, wear is minimal. The fibers individually and the brush as a whole are relatively robust against contamination. The very thin fibers will cut through film layers of contamination to maintain contact. Microfibers 60 are provided in sufficient quantity and a density within the rows to carry the current required to complete the circuit through the motor. The highly conductive nature of the microfiber material, and the ability to provide millions of densely packed fibers in a limited area facilitates use of the microfibers as a stator brush to conduct the required current.

Microfibers 60 are held in electric contact with commutator 26. However, electric contact does not necessarily require mechanical contact for all microfibers 60. The manner in which electric contact is established or maintained across gaps of various distances, such as by electric field emission, is well-known to those skilled in the art.

The exposed distal end portions of individual microfibers 60 can flex relative to other microfibers 60, and conditions such as air currents generated by the rotating armature, irregular surface contact of individual microfibers 60 against commutator 26, contact between microfibers and the like can cause some microfibers 60 to move small distances away from direct physical or mechanical contact with commutator 26. Accordingly, some but perhaps not all microfibers 60 are in direct physical contact with commutator 26 at any given time. In the present invention, as individual microfibers 60 move away from direct mechanical contact with commutator 26 electric contact is maintained across such gap distance.

Brush assembly 30 is positioned in motor 20 so that a substantial portion of the thin, lightweight conductive microfibers 60 are in physically contact with commutator 26, for direct current flow between brush assembly 30 and commutator 26 via mechanical and electrical contact between the microfibers commutator contacts 28. However, even if distal ends of some microfibers 60 are not in mechanical contact with commutator 26, the microfibers are in a closely spaced relationship to commutator 26 such that an ionized field is created, allowing current flow between microfibers 60 and commutator 26 across the gap. If mechanical contact exists, a current flows through the microfibers. When any of the microfibers lose electrical contact via mechanical contact, a breakdown due to local field emission will occur, thereby establishing electrical contact even without mechanical contact. Field emission is a function of the diameter of the microfiber. Since the microfiber diameter is very small, the electric field can exceed the field emission voltage even with a low voltage potential. Whereas, theoretically, the same general phenomenon can occur with conventional block carbon brushes, the required voltage potential is dangerously high due to the black nature of the conventional electric motor brush. In the present invention, the very small diameter of each individual microfiber 60 allows electric contact and current flow at low potential with respect to an individual microfiber 60.

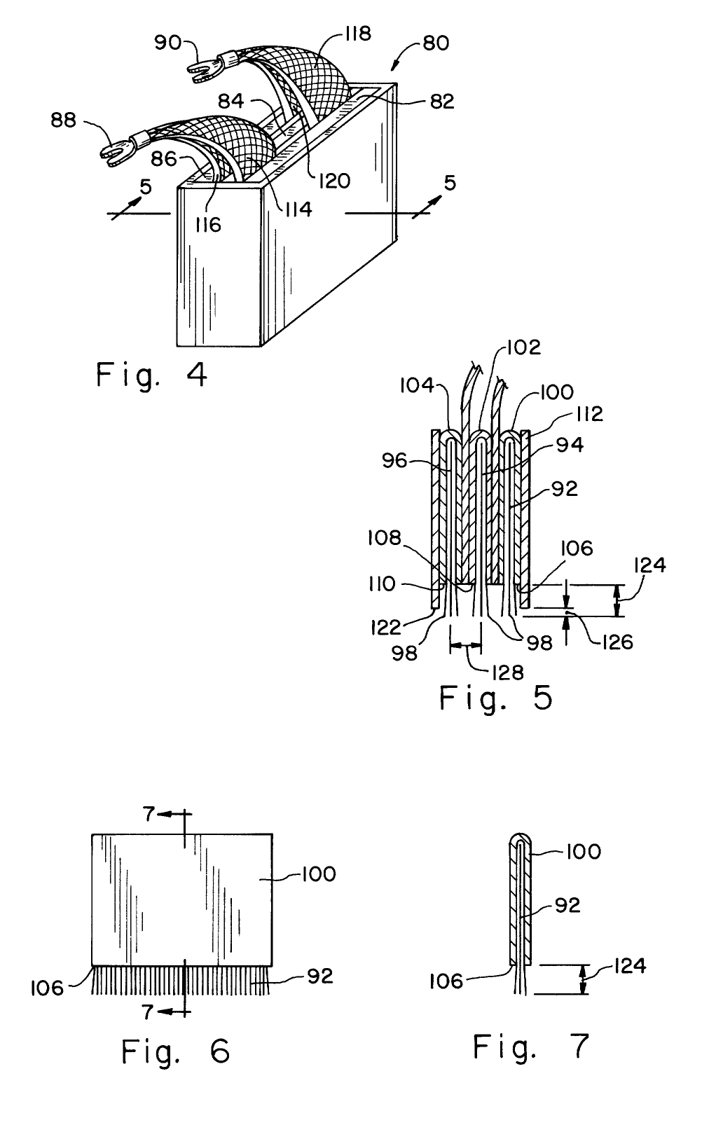

FIGS. 4-7 illustrate another embodiment of the present invention. A brush assembly 80 includes microfiber assemblies 82, 84, 86 and electric lead connectors 88, 90 for connection to the power source of the electric motor. Each microfiber assembly 82, 84, 86 includes a row 92, 94, 96 consisting of a plurality of individual microfibers 98 retained in microfiber holders 100, 102, 104, respectively. Microfibers 98 are similar to microfibers 60 described previously herein, and can be a single length strands or looped strands as described previously. Microfiber holders 100, 102, 104 are of similar materials as described for microfiber holders 62, 64, 66 described previously. Each is provided as a generally U-shaped sleeve folded on itself and crimped or compressed so as to contain and hold the individual microfibers 98 therein. Distal end portions of microfibers 98 extend past end edge surfaces 106, 108, 110 of U-shaped sleeve type microfiber holders 100, 102, 104, respectively. As described previously, electrically conductive, heat resistant adhesives or other materials can be used together with microfiber holders 100, 102, 104 for retaining the individual microfibers 98 therein.

Microfiber assemblies 82, 84 and 86 are contained within an enclosure 112, which can be conductive or nonconductive. Within enclosure 112, microfiber holders 92, 94, 96 are separated by electrical conductors in the nature of braided contacts 114 and 116 from electric lead connector 88, and braided contacts 118 and 120 from electric lead connector 90.

Enclosure 112 is of sufficient size to extend past the end edge surfaces 106, 108, 110 of microfiber holders 100, 102, 104 to provide a protective perimeter for the exposed distal end portions of the individual microfibers 98 during handling and installation. Only a small terminal portion of each microfiber 98 extends past an edge 122 of enclosure 112. Accordingly, a substantial extent of the exposed distal ends of microfibers 98 are laterally protected by enclosure 112, as best illustrated in FIG. 5.

FIG. 6 and FIG. 7 illustrate microfiber assembly 82, which is similar in construction to microfiber assemblies 84 and 86. Microfiber holder 100 is an elongated electrically conductive body, generally U-shaped in cross-section. Conductive microfibers 98 are provided in a densely packed continuous row from near one end of microfiber holder 100 to near the opposite end of microfiber holder 100. The length of the distal portions of fibers 98 extending past the edge surface 106 of holder 100 is designated by dimension indicator 124 in the drawings, and preferably is between about 2 millimeters and about 10 millimeters. The fiber has sufficient flexibility to provide an adequate contact area and force from the bent fiber on a sliding surface from the stiffness of the fibers while also minimizing wear of microfibers by limiting the force of contact against the commutator.

As shown in FIG. 5, enclosure 112 extends past the edge of the microfiber holders by a distance less than that designated by dimension indicator 124, such that a terminal portion of the distal end portions of microfibers 98 extend past edge 122 of enclosure 112. The length of the portions of microfibers 98 exposed beyond edge 122 of enclosure 112 is designated by dimension indicator 126, and preferably is between about 0.5 to and about 5 millimeters, to protect the microfibers from damage during handling and installation of the microfiber brush assembly.

Microfiber assemblies 82, 84, 86 are positioned adjacent each other in brush assembly 80, such that adjacent rows 92, 94, 96 of microfibers are spaced by a distance designated by dimension indicator 128, which is between about 1 to about 4 millimeters, to provide sufficient space for the deflection of microfibers.

The completed assembly can be held together by fasteners, such as rivets screws, bolts or other connectors extended through enclosure 112 and microfiber assemblies 82, 84 and 86. Adhesive, mechanical compression and the like can be used also.

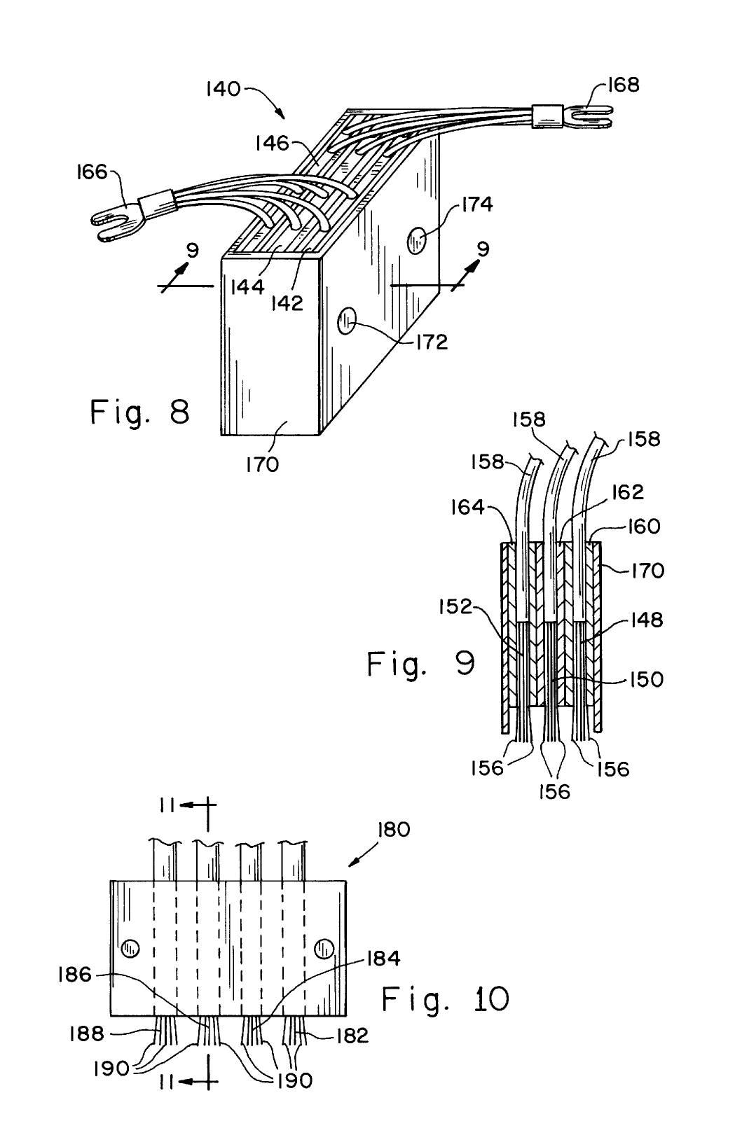

Referring now to FIGS. 8-9, yet another embodiment of the present invention is shown. Brush assembly 140 includes a plurality of microfiber assemblies 142, 144, 146 each including multiple microfiber bundles. In the exemplary embodiment shown, three microfiber assemblies 142, 144, 146 are illustrated; however, it should be understood that more or fewer microfiber assemblies can be used. Further, each microfiber assembly is illustrated having four microfiber bundles therein. FIG. 9 illustrates microfiber bundles 148, 150 and 152 in microfiber assemblies 142, 144, 146, respectively.

Each microfiber bundle is provided similar to multi-strand wire, with a plurality of microfibers 156 contained within a sheath 158, held in holders 160, 162, 164. Distal end portions of microfibers 156 project outwardly from one end of the sheath 158, and at an opposite end the fibers are connected to electric lead connectors 166, 168. The bundles and microfiber holders are fastened into an enclosure 170 using rivets 172, 174, screws, mechanical compression, adhesive, etc. The rows of bundles are spaced from each other by a distance similar to that spacing described between continuous rows of microfibers. Further, within a row, the individual fiber bundles can be spaced from one another by a similar distance.

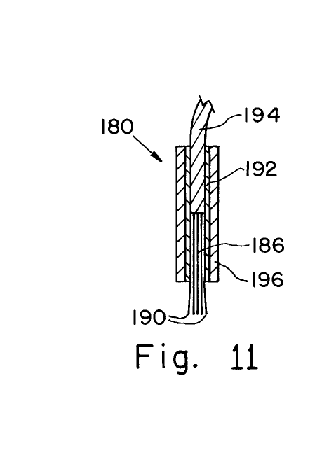

FIGS. 10 and 11 illustrate yet another microfiber assembly 180 having microfiber bundles 182, 184, 186 and 188, each including a plurality of microfibers 190. Microfiber bundles 182, 184, 186, 188 are contained within tubes such as tube 192 shown in FIG. 11. An electric lead 194 extends from the end of tube 192 opposite from microfibers 190. The tubes are retained in a microfiber holder 196.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

What is claimed is:

1. A stator brush assembly for the stator of an electric motor having a commutator and a power supply, said stator brush assembly comprising:
an electric lead for connecting said assembly to the power supply;
a microfiber assembly electrically connected to said electrical lead; and
microfibers in said microfiber assembly for carrying current between the commutator and power supply, said microfibers having exposed distal end portions to form flexible electrical connections to the commutator.

2. The stator brush assembly of claim 1, including a plurality of microfiber holders in said microfiber assembly, some of said microfibers provided in each of said microfiber holders and having distal end portions extending outwardly from an edge surface of the microfiber holder to form flexible electrical connections to the commutator.

3. The stator brush assembly of claim 2, said microfibers provided in rows in each said microfiber holder.

4. The stator brush assembly of claim 2, said microfibers provided in bundles, and each said microfiber holder including a plurality of said bundles in spaced relation to each other.

5. The stator brush assembly of claim 2, including an enclosure surrounding said microfiber holders, said enclosure having an edge portion extending past said edge surfaces of said microfiber holders a distance less than the lengths of said distal end portions of said microfibers.

6. The stator brush assembly of claim 1, including an enclosure surrounding said microfiber assembly and shielding portions of said microfiber distal ends.

7. The stator brush assembly of claim 1, including a plurality of microfiber holders each connected to an electric lead for connecting to the power supply, some of said microfibers provided in each of said microfiber holders, and an insulating sheet disposed between each pair of adjacent microfiber holders.

8. A stator for an electric motor having a commutator, said stator comprising:
an electric power supply;
an electric lead electrically connected to said electric power supply;
a brush assembly electrically connected to said power supply by said electric lead; and
microfibers in said brush assembly in sufficient quantity and density to conduct an electric current between said power supply and the commutator, said microfibers having distal end portions forming electrical connections to the commutator.

9. The stator of claim 8, said electrical connections to the commutator including mechanical connections and non-mechanical connections.

10. The stator of claim 8, said brush assembly including a plurality of microfiber holders, and some of said microfibers disposed in each of said holders.

11. The stator of claim 10, said microfibers having distal end portions extending outwardly beyond edge surfaces of said holders.

12. The stator of claim 11, said microfibers arranged in rows.

13. The stator of claim 11, said microfibers provided in bundles and said bundles disposed in rows in spaced relationships to one another.

14. The stator of claim 11, including an enclosure surrounding said holders, said enclosure having a portion extending past said edge surfaces of said holders a distance less than lengths of said distal end portions of said microfibers.

15. An electric motor comprising:
an armature having a commutator with electrical contacts;
a power supply;
a brush assembly electrically connected to said power supply; and
microfibers in said brush assembly establishing electrical connections to said electrical contacts of said armature.

16. The motor of claim 15, said brush assembly including a plurality of microfiber holders, and some of said microfibers provided in each of said microfiber holders.

17. The motor of claim 15, said electrical connections established by said microfibers including both mechanical electrical connections and nonmechanical electrical connections.

18. The motor of claim 15, said brush assembly including a plurality of microfiber holders, some of said microfibers disposed in each of said holders and having distal end portions extending outwardly beyond edge surfaces of the holders in which the microfibers are held.

19. The motor of claim 18, including an enclosure surrounding said microfiber holders, said enclosure having an edge portion extending beyond said edge surfaces of said microfiber holders a distance less than the lengths of said distal end portions of said microfibers

20. The motor of claim 18, said microfiber holders having rows of microfibers therein.

21. The motor of claim 18, said microfibers provided in bundles and a plurality of bundles held in each said microfiber holder in spaced relationship to each other.
